(19) United States
(12) Patent Application Publication
(10) Pub. No.: US 2006/0099023 A1
(43) Pub. Date: May 11, 2006

(54) Keyboard and stand for portable computing and communication devices

(76) Inventors: Michael Katz, Vancouver (CA); Roger Li, Vancouver (CA); Ying-Chiu Chan, Vancouver (CA)

Correspondence Address: Clifford W. Vermette;Box 40, Granville Square, 200 Granville Street, Suite 230, Vancouver, BC, V6C 1S4, CA

(21) Appl. No.: 10/974,884

(22) Filed: Oct. 28, 2004

(51) Int. Cl. B41J 5/14

(52) U.S. Cl. 400/472

(57) ABSTRACT

The present invention provides a fully functional keyboard in a form factor no larger than that of a small cell phone. The keyboard achieves this small form factor by utilizing an entirely unique keyboard layout in which the keys in the top and bottom letter rows are reduced in the North-South axis, (the transverse axis i.e. the axis at right angles to the letter rows) whilst all the keys in the middle letter row, (the “Home” row) are maintained as full-size, (18 mm×18 mm with 1 mm spacing) in both the North-South and East-West axis. (the longitudinal axis i.e. the axis parallel to the letter rows) The size is further reduced by folding the keyboard. This is achieved by having the keyboard divided into four sections, hingedly connected along three fold lines, whereby the keys are cut at the fold lines to permit folding of the keyboard into a “W” shape. The size is further reduced by constructing each section of the keyboard in an extremely thin form-factor. (0.125″ or 3.2 mm) Finally, all this is achieved without adding an outside shell or frame. A stand is constructed in the form factor of two and/or three credit cards, which can be unfolded in various manners into various stands, all of which can support a PDA or cell phone with the screen placed at an angle of 45 degrees to the vertical and in such a manner that the PDA or cell phone can receive the keystroke signals transmitted from the IR transmitter in the keyboard.

### RELATED APPLICATION

This application claims the benefit of prior filed provisional application, Application No. 60/513,987.

### FIELD

The present invention relates to mobile keyboards and in particular to a wireless and plug-in keyboard particularly useful with PDA's, cellular telephones and other handheld information processing devices.

### BACKGROUND

Due to their small size and portability, various handheld computing devices have become popular as portable computers, personal organizers and as wireless communication devices. Such devices include the Personal Digital Assistant (PDA) such as those manufactured by Palm, Inc., Handspring, Inc., Hewlett Packard, Casio Computer Co., Ltd. and SONY Personal Organizers, palm-size computers and Internet-ready cellular telephones as manufactured by Motorola, Inc., Nokia and Siemens AG, for example.

These devices typically use a pen or stylus to either hand-write characters or select letters from a simulated keyboard by tapping on the screen. Alternatively, a small thumb keyboard is used. In the case of a simulated keyboard, the user has only one character-selecting element, so the data entry is very slow. In the case of hand-written characters, the computing device relies on handwriting recognition software to interpret the user notations, and consequently there are frequent errors in data entry, which must be corrected. In the case of the thumb keyboard, only two fingers may be used.

Computer users are most familiar with entering data into a computer by means of a keyboard. Indeed many computer users are touch-typists who require a qwerty keyboard, i.e. a keyboard in which the keys are arranged in the universal arrangement, to type at full speed and efficiency.

The lack of a standard keyboard greatly reduces the usefulness of hand-held devices for word processing, email, Internet access or software applications. However, carrying a standard size keyboard with a hand-held device would defeat its portability and size advantages and a standard size keyboard cannot be reduced to the size of a PDA or other hand-held computer without folding and/or collapsing the keyboard or projecting an image onto a table or screen.

Folding keyboards have therefore been developed for PDA's and similar devices. See, for example, U.S. Pat. No. 6,174,097 issued Jan. 16, 2001 to Simon Daniel entitled “Collapsible Keyboard”. The latter keyboard is sold under the Trademark STOWAWAY by a company called “Think Outside Inc.” While such a device provides a folding full-size keyboard for a PDA or cell phone, it is relatively large and complex to manufacture due to its multiple slidable keys and spring connections to effect collapsing. Also the PDA connects to the keyboard through a built-in docking station, which requires a different design for each type of hand-held device. To connect the PDA with the STOWAWAY keyboard, the connector of the PDA slides into a corresponding connector on the keyboard, so different hardware connections must be provided for the keyboard to be used with different devices. As many keyboards, are required, therefore, as there are different hand-held devices.

Folding keyboards also have been developed for PDA's and similar devices in which the keyboard communicates wirelessly with the devices. This solves the abovementioned problems regarding the need to create a separate keyboard for every make of device.

Notwithstanding the usefulness of the keyboards mentioned, the need for a smaller form-factor in order to effect greater ease of carrying, remains. This is particularly true in the case of typing into cell phones.

Cell phones have become smaller and smaller and now have reached a size and weight that when placed in a pocket, can best be described as an “unconscious carry”. This means that the cell phone has been reduced to so small a size and weight, that a person will not even be aware that the device is in his pocket unless he looks for the cell phone specifically.

There is a need for a portable folding keyboard for use with hand-held computers which functions as a full-size keyboard, which can be readily used with different devices, is small enough to partner with the smallest cell phones, and when placed in a pocket, will be so small and light that it can be best described as an “unconscious carry”. That is a portable folding keyboard is needed which the user will not even be aware is in his or her pocket.

The size and spacing of the keys on the standard keyboard were determined by the size of the human hand and fingers. For each key to be provide tactile feedback, a travel motion of at least 2 mm was required. More importantly was the “pitch” of the keyboard, which is the distance between the center of the keys in both the North South and East-West axis. In this application the direction shall mean the direction perpendicular to the length of the keyboard whereas the East-West direction shall mean in the direction along the length. It has been established as an unchangeable fact that a full-size keyboard must have a pitch of 19 mm. If this is changed, even by 1 mm, the functionality, that is the comfort and accuracy of the keyboard, is affected adversely.

Until the advent of the sub-notebook keyboard which reduced the pitch by 10% to 17 mm, 19 mm pitch had been considered to be unchangeable. In the aforementioned reduction, users accepted the reduced functionality in favor of portability.

Until Michael Katz invented the “scalloped key” (U.S. Pat. No. 6,594,142) typists had two choices, either a large functional keyboard or a smaller cramped keyboard. Katz realized, however, that provided the center letter row was full-size, one could reduce the dimension of the keys in the North-South direction for the rows above and below the center row. This could be done if a “backboard” or “scallop” was provided to stop the typists fingers from overrunning the reduced keys.

This worked excellently until Katz developed another keyboard layout. The layout provides full-size keys in the center letter rows and reduced size keys in the North-South direction in the rows above and below the center row.

### SUMMARY OF THE INVENTION

According to the invention there is provided a foldable keyboard for use with a portable or stationary communication device, comprising a plurality of sections joined edge-to-edge to form a flat panel having a width equal to a total width of the plurality of sections. Each section contains keys and has a joint between it and an adjacent section. In addition, each section is foldable with respect to the adjacent section about the joint. The keys lie along at least three rows with keys in a center row being full-sized in two orthogonal directions and keys in top and bottom rows on either side of and adjacent to the center row being full-sized along a length of the top and bottom rows but reduced in size in the North-South direction. The keys in the top and bottom rows have no scalloped projections.

The foldable keyboard may have a lock operative to lock the plurality of sections together in an unfolded position. The lock may comprise a key slidable in a keyway, with the key and keyway extending across all of the joints, the key having hinged couplings normally aligned with the joints when the sections are foldable and movable away from the joints with the key extending across each of the joints and thereby locking each one of the sections against folding movement relative to others of the sections.

With the provision of full-size keys on the center letter row, no “backboard” or scallop or any other form of “stop” is necessary on the other letter rows. This is a profound change from all previous keyboard layouts.

Provided the center letter row (the “Home” row) is full-size, the upper and lower letter rows can be reduced in the North South axis, without affecting the functionality demanded by touch-typing. The reason for this is because of the particular dynamics involved in touch-typing. Unlike “hunt and peck” typing, in which the fingers are flying all over the keyboard, in touch typing the typists sets the four fingers of the left hand on the letters “A” “S” “D” “F” and the four fingers of the right hand on the letters “J” “K” “L” “;:”. This finger position is maintained at all times with only one finger at a time moving to strike any of the other letters whilst maintaining the other seven fingers in their original respective locations, i.e. the fingers lightly contact the letters as described above. It is because the typist's fingers remain in their original positions that the center letter row is known as the “Home” row, i.e. the fingers stay at “Home”. It is because the typists fingers have to move only a very small distance to the letters on the upper and lower letter rows and that these movements occur only one key at a time that it is not necessary for the keys in the upper and lower letter rows to be equal in size in the North-South direction to the keys in the center letter row.

It is this innovation of reducing the upper and lower letter rows in the North-South direction, that allows the present keyboard and all future keyboards to be decreased in size in the North-South direction, whilst retaining full touch-typing functionality.

In order to make the keyboard the size of a cell phone, in addition to the need for a new keyboard layout as described, it is necessary to fold the keyboard.

None of the previous mobile keyboards (including Katz') provide a full size keyboard small enough to achieve “unconscious carry”.

In a further aspect of the invention, there is provided an entirely unique stand for folding a PDA or cell phone whilst typing into same. In order to avoid reflection and to properly read a screen of a PDA or cell phone, it is necessary for the screen to be at an angle of 45 degrees from the vertical. This requires the PDA or cell phone to be placed in a stand. To date stands have been quite large and if attached to the keyboard, add to the bulk and thereby adversely affect mobility. The present stand can be constructed of two credit cards, joined, cut and folded in various configurations. After use, the stand is folded back into the configuration of two joined credit cards and stored in the credit card compartment of a normal wallet.

The present invention therefore provides for a folding keyboard in which the middle letter row (the “Home” row) consists of full-size keys, whilst the upper and lower letter rows, are full-size in the East-West axis but reduced in the North-South axis. The aforementioned reduction in key-size does not adversely affect touch-typing.

The centre letter row (the “Home” row) consists of keys, sized in the range of 16-18 mm×16-18 mm, with 1 mm gaps, (full-size keys are 18 mm×18 mm with 1 mm gaps) whilst the upper and lower letter rows, are approximately full-size in the East-West axis (16-18 mm), except for keys D, H, and L in the center row and C and N in the lower row, and reduced in the North-South axis. The reduced keys in the upper and lower letter rows will be 9-12 mm in the North-South axis.

The folding keyboard may have a plurality of keys generally corresponding in spacing, size and location to the keys of a standard personal computer keyboard, (other than the reduction of the size of the keys in the upper and lower letter rows in the North-South axes) and comprising four sections hingedly connected along three fold lines, in the form of a “W” whereby the keys are cut along the fold lines to permit folding of the keyboard.

Each of the four sections of the keyboard may be constructed in an extremely thin form factor (approx. ⅛″) so that when the four sections are folded together, the resultant thickness will not be greater than the thickness of a small cell phone (approx. ½″).

This extremely thin form-factor may be achieved by avoiding the addition of any shell or frames to the four sections of said keyboard.

The keyboard may allow for a plug-in module which contains a battery and allows the keyboard to wirelessly communicate with a computer, cell phone etc. by means of infrared technology.

The keyboard may allow for a plug-in module, which contains a battery and allows the keyboard to wirelessly communicate with a computer, cell phone etc. by means of BLUETOOTH (or other) wireless technology.

The keyboard may allow for a plug-in module, which incorporates a plug to allow PDA's and cell phones to plug directly into the keyboard. In this case, the module does not contain a battery and power required for the keyboard is drawn from the PDA or cell phone.

In another aspect of the invention the folding stands may be able to be folded into the form factor of two credit cards and stored in a wallet. (two credit cards measure 3.4″×2.1″×0.06″)

The stands preferably are able to stand on a flat surface without support whilst supporting a PDA or cell phone so that the screen is at an angle of approximately 45 degrees to the vertical and receive the IR communication from an IR equipped keyboard.

The stand may be constructed in a number of variations of form factors of two credit cards, cut and hingedly connected to each other in a manner that allows the cut and hingedly connected credit cards to be unfolded into stands which support a PDA or cell phone with the screen placed at an angle of 45 degrees to the vertical and in such a manner that said PDA or cell phone is able to receive the keystroke signals transmitted from the IR transmitter in the keyboard, directly into the IR receiver of said PDA or cell phone or, in the alternative, to allow the said PDA or cell phone to receive any other wireless signal from the keyboard. (e.g. BLUETOOTH, RF etc.)

Alternatively, the folding stand may have a form factor of three credit cards and includes a mirror mounted on an adjustable sliding bracket, which bracket and mirror can be adjusted to deflect the IR beam from the keyboard into the PDA or cell phone.

The stand may be constructed in the form factor of three credit cards, cut and hingedly connected to each other in a manner that allows the cut and hingedly connected credit cards to be unfolded into a stand which includes a reflector and supports a PDA or cell phone with the screen placed at an angle of 45 degrees to the vertical and in such a manner that the PDA or cell phone is able to receive the keystroke signals transmitted from the IR transmitter in the keyboard, via the reflector attached to said stand which reflector reflects the signals transmitted from the IR transmitter in the keyboard into the IR receiver of said PDA or cell phone.

The stand may further be constructed in the form factor of three credit cards, cut and connected to each other in a manner that allows the credit cards, to be hingedly connected to the keyboard and able to be unfolded into a stand which includes a reflector and fiber-optic cable and which stand can support a PDA or cell phone with the screen placed at an angle of 45 degrees to the vertical and in such a manner that said PDA or cell phone will be able to receive the keystroke signals transmitted from the keyboard via the signals transmitted from the IR transmitter in the keyboard transmitting said signals via a fiber-optic cable to a reflector which reflector reflects said signal into the IR receiver of said PDA or cell phone.

The folding stand may be able to be folded into the form factor of three credit cards and stored by attaching to the keyboard. When the stand is unfolded into the “typing” position, the PDA or cell phone can be supported by the plug-in module portion of the keyboard.

In yet a further aspect of the invention there is provided a keyboard for use with a portable or stationary communication device, comprising a flat panel and a plurality of keys lying along at least a center row and a top and bottom row of said flat panel. The keys in the center row are full-sized along a length of the center row and perpendicular to the length of the center row and keys in a top and bottom row on either side of and adjacent to the center row are full-sized along a length of said top and bottom rows but reduced in size in a direction perpendicular to said top and bottom rows. The keys in rhw top and bottom rows have no scalloped projections.

### BRIEF DESCRIPTION OF DRAWINGS

Further features and advantages will be apparent from the following detailed description, given by way of example, of a preferred embodiment taken in conjunction with the accompanying drawings, wherein:

FIG. 1 is a plan view of a keyboard in fully open configuration;

FIG. 2 is a plan view of the underside of the keyboard of FIG. 1 in fully open configuration;

FIG. 3 is a left end elevation view of the keyboard in the direction A of FIG. 1;

FIG. 4 is a right end elevation of the keyboard in the direction B of FIG. 1;

FIG. 5 is a top end elevation of the keyboard in the direction C of FIG. 1;

FIG. 6 is a bottom end elevation of the keyboard in the direction D of FIG. 1;

FIG. 7 is a plan view of the keyboard in a folded, closed configuration;

FIG. 8 is a left side elevation view of the keyboard in the direction E as shown in FIG. 7;

FIG. 9 is a right side elevation view of the keyboard in the direction F shown in FIG. 7;

FIG. 10 is a top end elevation view of the keyboard in the direction G shown in FIG. 7;

FIG. 11 is a bottom end elevation view of the keyboard in the direction H shown in FIG. 1;

FIG. 12 is a cross-section of a keyboard of FIG. 7 taken along line X-X with the keyboard closed;

FIG. 13 is a cross-section of a keyboard of FIG. 7 taken along line Y-Y with the keyboard closed;

FIG. 14 is a cross-section of a keyboard of FIG. 1 taken along line Z-Z with the keyboard open;

FIG. 15 is a magnified portion of the cross-section of the keyboard of FIG. 1 taken along line Z-Z with the keyboard open;

FIG. 16 is an end elevation of a keyboard according to the version shown in FIG. 1 in direction D of FIG. 1 in partially open configuration;

FIG. 17 is an end elevation of a keyboard of FIG. 1 in direction D in a partially folded configuration;

FIG. 18 is a plan view of a keyboard of FIG. 1 showing a partial cutaway of the top edge of the keyboard with the lock in “unlocked” position;

FIG. 19 is a plan view of a keyboard of FIG. 1 showing a partial cutaway of the top edge of the keyboard with the lock in “locked” position;

FIG. 20 is a perspective view of a keyboard of FIG. 1 fully open;

FIG. 21 is a perspective view of a keyboard of FIG. 1 partially folded;

FIG. 22 is a plan view of the keyboard of FIG. 1 showing the body of the keyboard with the plug-in module detached;

FIG. 23 is a side view of the keyboard of FIG. 1 showing the body of the keyboard with the plug-in module detached;

FIG. 24 is a plan view of a the IR plug-in module for use with the keyboard of FIG. 1;

FIG. 25 is a plan view of a “Plug-type” plug-in module for use with the keyboard of FIG. 1;

FIG. 26 is a plan view of a BLUETOOTH plug-in module for use with the keyboard of FIG. 1;

FIG. 27 is an end view of the “Plug-type” plug-in module as shown in FIG. 25 for use with the keyboard of FIG. 1;

FIG. 28 is an end view of the BLUETOOTH plug-in module as shown in FIG. 26 for use with the keyboard of FIG. 1;

FIG. 29 is an end view of an IR plug-in module as shown in FIG. 24 for use with a keyboard of FIG. 1;

FIG. 30 is a plan view of a first embodiment of a stand folded (constructed of two credit cards) for use with the keyboard of FIG. 1;

FIG. 31 is a section through the stand folded (constructed of two credit cards) taken along the line ww shown in FIG. 30;

FIG. 32 is a plan view of the underside of the stand folded (constructed of two credit cards) of FIG. 30 for use with the keyboard of FIG. 1;

FIG. 33 is a top view of the stand unfolded (constructed of two credit cards) of FIG. 30 for use with a keyboard according to the version shown in FIG. 1;

FIG. 34 is a front view of the stand unfolded (constructed of two credit cards) of FIG. 30 for use with the keyboard of FIG. 1;

FIG. 35 is a side view of the stand unfolded (constructed of two credit cards) of FIG. 30 for use with a keyboard of FIG. 1;

FIGS. 36-41 (inclusive) are perspective views of the unfolding sequence of the stand (constructed of two credit cards) of FIG. 30 for use with the keyboard of FIG. 1;

FIGS. 42-46 (inclusive) are perspective views of the unfolding sequence of a second embodiment of the stand (constructed of two credit cards) of FIG. 30 for use with the keyboard of FIG. 1;

FIG. 47 is a side view of the second embodiment of the stand (constructed of two credit cards) of FIG. 30 for use with the keyboard of FIG. 1;

FIG. 48 is a front view of the second embodiment of the stand (constructed of two credit cards) of FIG. 30 for use with the keyboard of FIG. 1;

FIG. 49 is a top view of the second embodiment of the stand (constructed of two credit cards) according to the version shown in FIG. 30 for use with the keyboard of FIG. 1;

FIGS. 50 and 51 are perspective views of the unfolding sequence of the third embodiment of the stand (constructed of two credit cards) of FIG. 30 for use with a keyboard of FIG. 1;

FIG. 52 is a perspective view of a fourth embodiment of the folding stand, (constructed in the form factor of three credit cards) for use with the keyboard of FIG. 1, in an unfolded position and attached to the keyboard.

FIG. 53 is a top view of the fourth embodiment of the folding stand (constructed in the form factor of three credit cards) of FIG. 52, for use with a keyboard of FIG. 1;

FIG. 54 is a back view of the fourth embodiment of the folding stand (constructed in the form factor of three credit cards) of FIG. 52, for use with the keyboard of FIG. 1;

FIG. 55 is a side view of the fourth embodiment of a folding stand (constructed in the form factor of three credit cards) of FIG. 52, for use with the keyboard of FIG. 1;

FIG. 56 is a front view of the fourth embodiment of the folding stand (constructed in the form factor of three credit cards) of FIG. 52, for use with a keyboard of FIG. 1;

FIG. 57 is a section through the fourth embodiment of the folding stand (constructed in the form factor of three credit cards) of FIG. 53, for use with the keyboard of FIG. 1;

FIGS. 58 through 60 (inclusive) are perspective views (shown from the back of the stand) of the unfolding sequence (and showing the connection to the keyboard) of the fourth embodiment of the folding stand (constructed in the form factor of three credit cards) for use with the keyboard of FIG. 1;

FIGS. 61 through 64 (inclusive) are perspective views (shown from the front of the stand) of the unfolding sequence (and showing the connection to the keyboard) of the fourth embodiment of the stand (constructed in the form factor of three credit cards) for use with the keyboard of FIG. 1;

FIG. 65 is a top view of an alternative embodiment of the keyboard; and

FIG. 66 is an edge view of the keyboard of FIG. 65 in an unfolded position taken along the line A-A of FIG. 65;

FIG. 67 is an edge view of the keyboard of FIG. 65 in a folded position taken along the line A-A of FIG. 65;

FIG. 68 is a sectional edge view of the keyboard of FIG. 65 in an unfolded, locked position taken along the line B-B of FIG. 65;

FIG. 69 is a sectional edge view of the keyboard of FIG. 65 in an unfolded, unlocked position taken along the line B-B of FIG. 65;

FIG. 70 is a sectional edge view of the keyboard of FIG. 65 in a folded, unlocked position taken along the line B-B of FIG. 65; and

FIG. 71 is a a plan view of the underside of the keyboard of FIG. 65.

### DETAILED DESCRIPTION WITH REFERENCE TO THE DRAWINGS

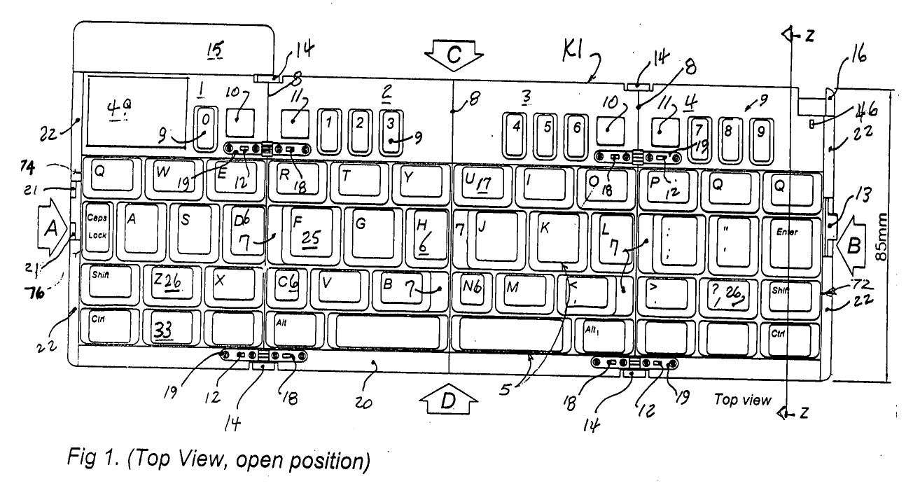

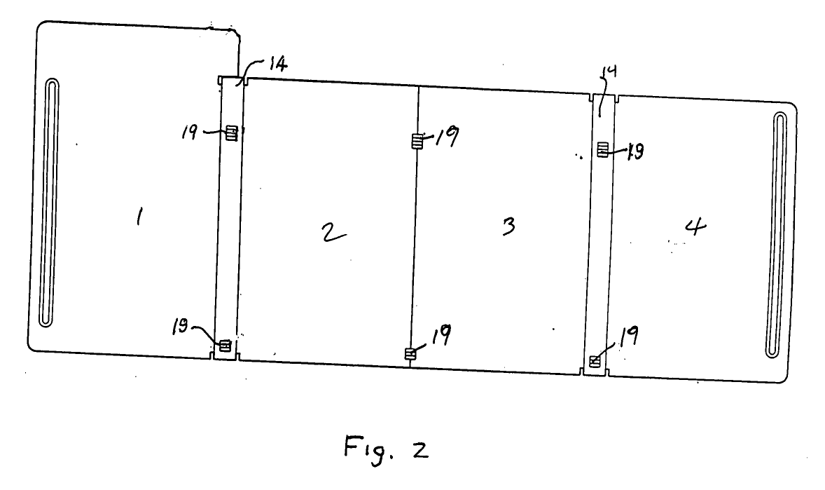

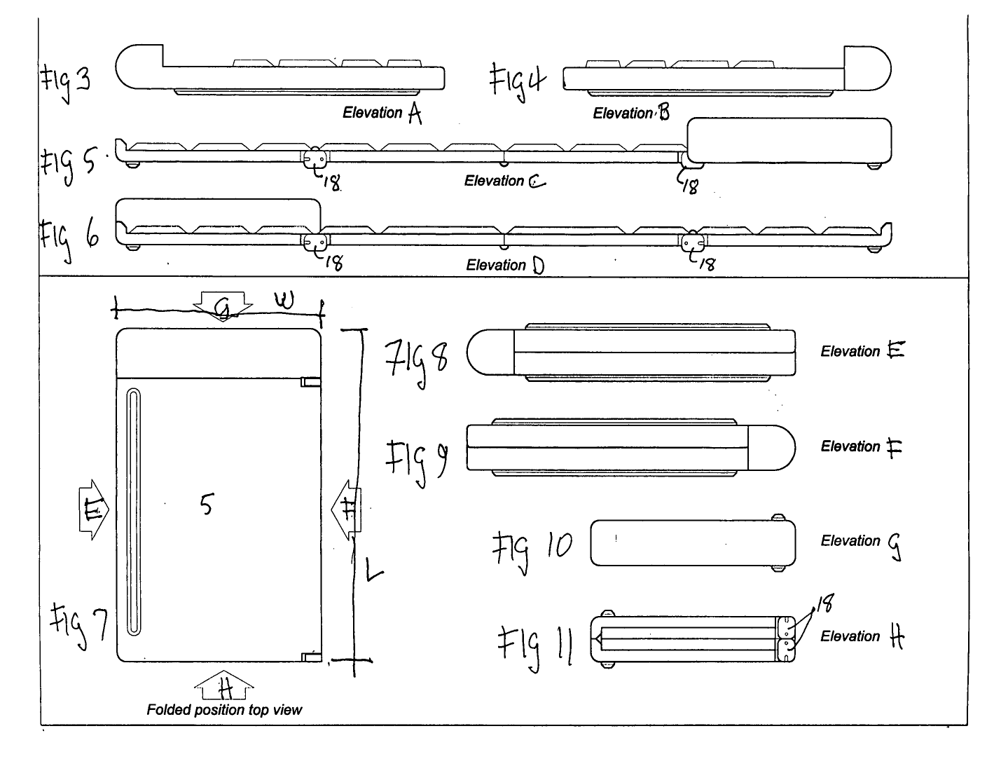

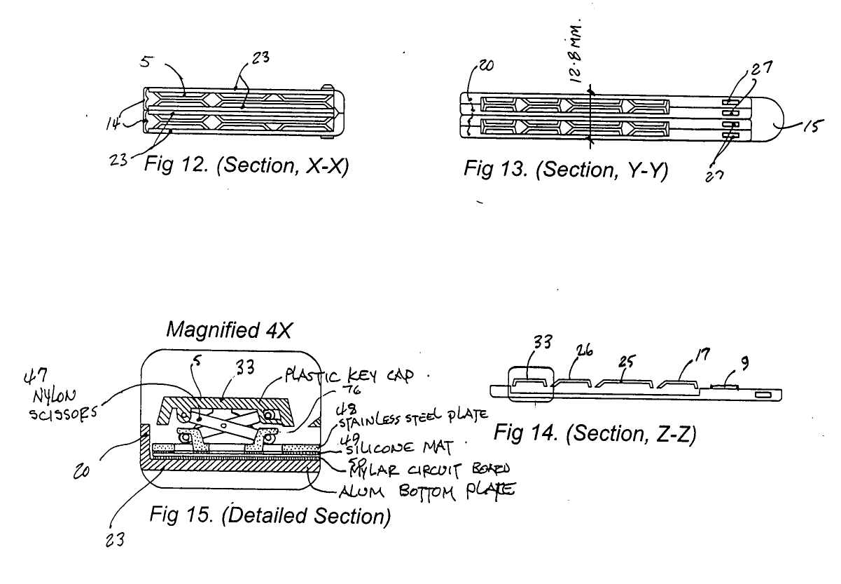

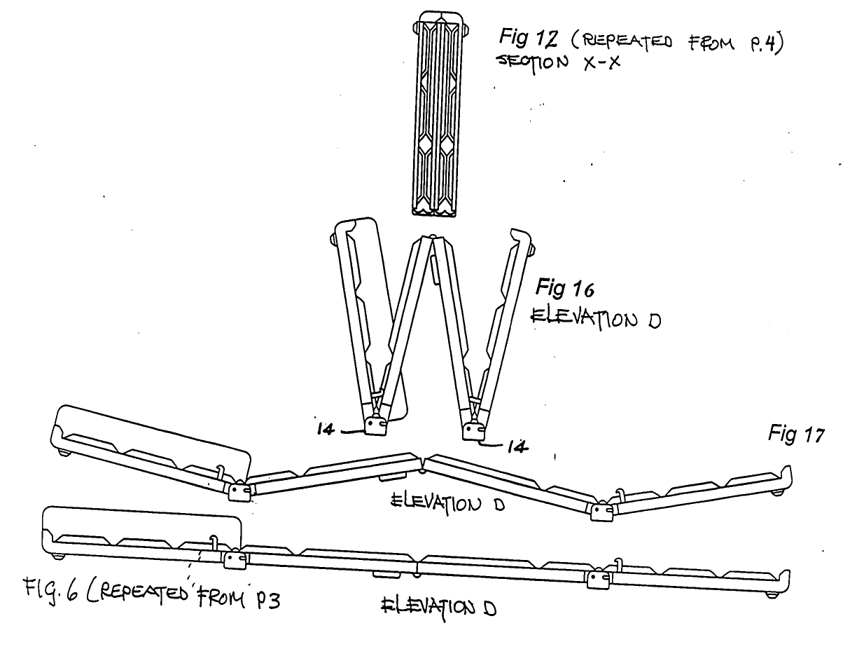

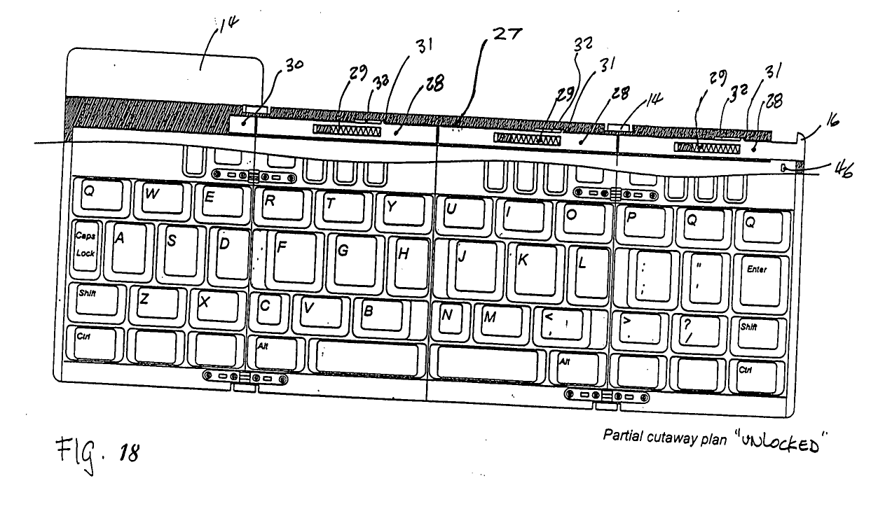

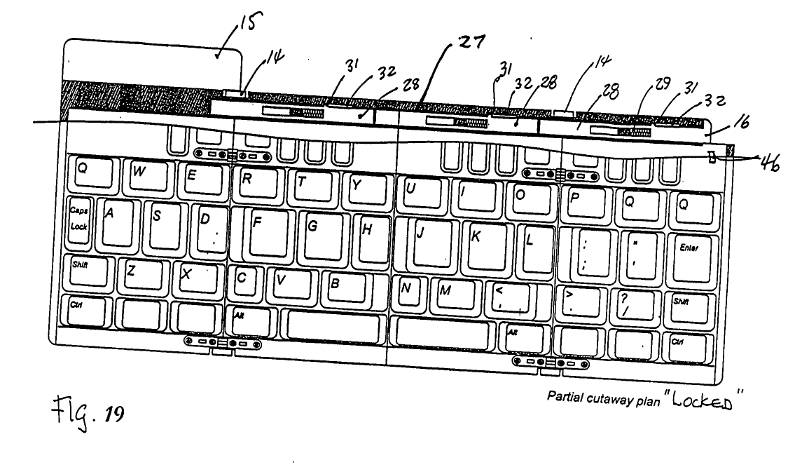

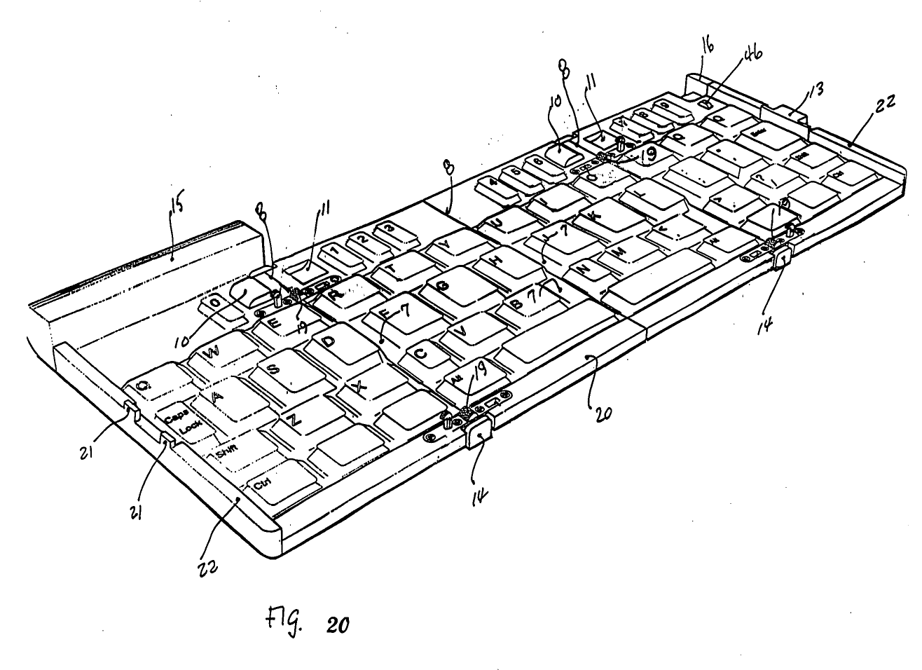

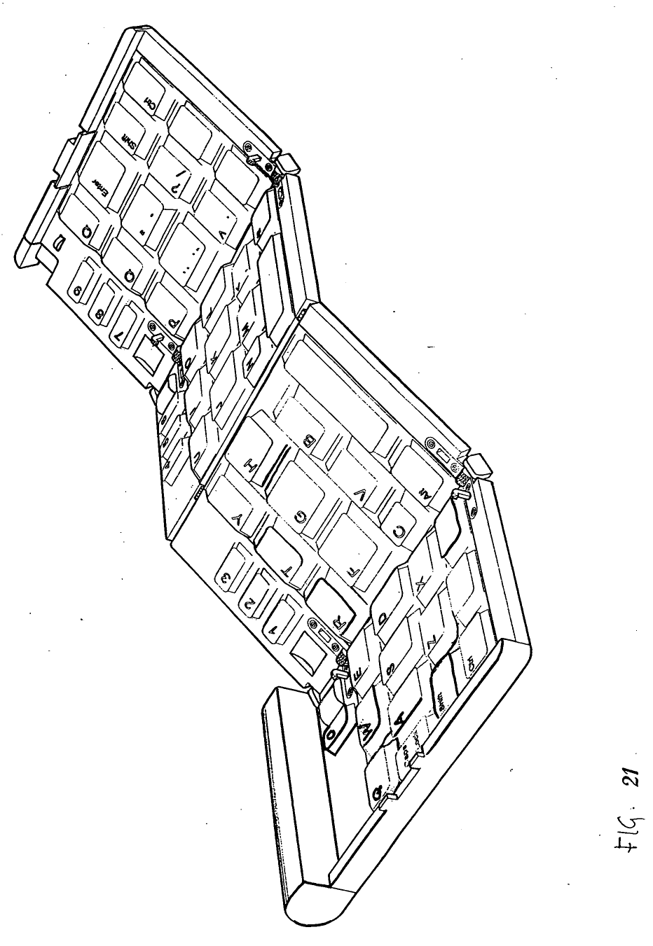

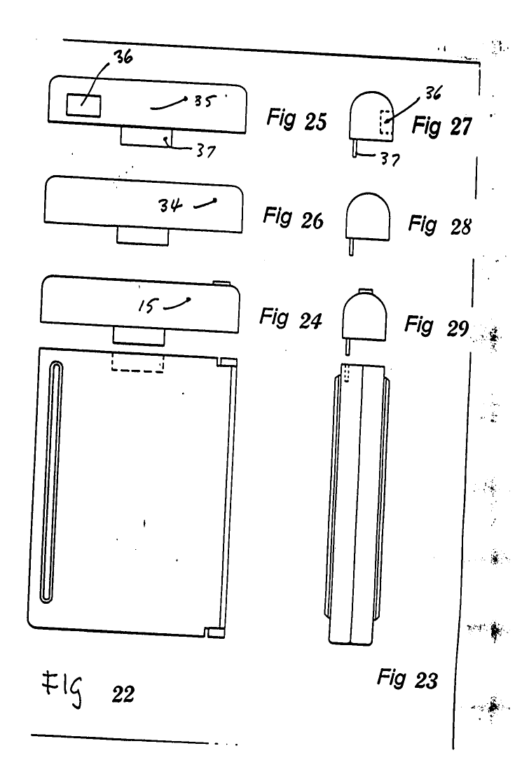

Referring to FIGS. 1 through 30 of the drawings, a folding keyboard K1 having keys 5 is shown having four sections 1, 2, 3, and 4 hinged at abutting ends 8 to be foldable from a fully open configuration shown in FIG. 1 to a folded configuration shown in FIG. 7. The center row 70 has keys, which are of a standard size whereas rows 72 and 74 below and above the center row have keys, which are a standard size in the East-West direction (i.e., from one side of the keyboard to the other) but are less than standard size in the North-South direction (in the direction perpendicular to the rows 70, 72, and 74).

The layout of keyboard K1 is as per FIG. 1. The middle letter row 70 (the “Home” row) consists of keys sized in the range of 16-18 mm×16-18 mm, with 1 mm gaps, (full-size keys are 18 mm×18 mm with 1 mm gaps). The upper letter row 74 and lower letter row 72 are approximately full-size in the East-West axis (16-18 mm) and reduced in the North-South axis to 9-12 mm. The keys in the lower row 72 are approximately full-size in the East-West axis (16-18 mm) and reduced in the North-South axis to 9-12 mm. The keys in the top row 9 are reduced in the North-South axis to 9-12 mm and in the East-West axis to 5-8 mm.

The keys 5 are cut along the fold lines to permit folding of said keyboard. In FIG. 1, the keyboard sections 1, 2, 3, and 4 fold along fold lines 8 which decreases the “D”, “C”, “H”, “N”, “L”, and “.>” keys. The keys “F”, “J”, “B”, and “,<” (adjoining the cut keys) are enlarged by means of adding a lowered portion to these keys. The lowered portion takes up the space of the previous portions of the keys in those areas.

The keys 5, as shown in FIG. 15, are in the form of a scissor structure with scissor members 47 pivotally attached at their intersection and having ends pivotally connected to upstands 76 on the stainless steel plate 48. A plastic key cap pivotally connects to the upper ends of the scissor members 47.

When the keyboard K1 is folded, the keys 5, are compressed so that the thickness of the keyboard K1 can be minimized.

When the keyboard K1 is unfolded, the keys 5, return to their fully extended position as shown in FIG. 15. Keys 5 are very thin compared to standard keyboard keys and project approximately 1/32″ above the face of the keyboard. A key motion of only 1/32″ is required. The entire keyboard, therefore, is extremely thin, i.e. ½″ to ⅝″ thick in the folded position.

The four sections 1, 2, 3, and 4 of the keyboard K1 make up a full-size keyboard with each section being of a width of approximately 2.3″ and the keyboard having a folded length of 3.7″.

The keyboard K1 has a stainless steel base plate 48, with upstands 76, which retains the keys 5 by means of nylon scissor switches 47 which are attached to the upstands 76. As in existing electronic keyboards, a silicone matt molded with small dome “springs” 49 is provided on which keys 5 sit and which biases keys 5 upwardly when not depressed by the user. A mylar printed circuit board 50 is provided between base 23 and mat 49. An electrical contact is provided on the underside of mat 49 under each key 5, so that when the key 5 is depressed, the appropriate electrical circuit is completed in circuit board 50 to signal to the microprocessor that the key has been depressed.

Keys on a standard personal computer keyboard, which are redundant for most applications, such as the numeric keypad, and a function key row, are removed.

To permit the folding of the keyboard, the “D” “C” “H” “N” “L” “.>” keys are reduced in size by an amount small enough to have no effect on the typing action. (the keys are reduced by 25% i.e. from 18 mm to 12.75 mm)

In FIG. 1, hinges 19 are located above and below the keyboard and allow the four sections 1, 2, 3 and 4 of the keyboard K1 to align together precisely when in the open configuration.

Keys 5 have sloped sides as in standard keyboards in which the keys are tapered from ¾″ width at the base to ½″ width at the top, finger-contacting surface.

Because of the fact that the finger-contacting surface of normal keyboards are only ½″, reducing the top of the “D” “C” “H” “N” “L” “.>” keys to 13/32″ will not adversely affect the functionality of the keyboard.

The end views of the open and folded keyboard K1 are shown in FIGS. 3-6 and 8-11. Compartment 15 is provided to house the battery and IR. Compartment 49 is provided to house the processor, connections and the like.

FIGS. 24-29 shows three plug-in modules, 15, 34 and 35. Any of the three modules can be plugged into the keyboard. In this way, the keyboard will cater to the various technologies available and to the differing user needs.

Module 15 contains a battery and Infrared. The keystrokes are communicated via IR from the keyboard to the IR receiver in the receiving PDA, cell phone or computer device (not shown).

Module 34 contains a battery and a BLUETOOTH (Trademark) wireless communication system. The keystrokes are communicated via BLUETOOTH wireless communication from the keyboard to the BLUETOOTH receiver in the receiving PDA, cell phone or computer device.

Module 35 contains a plug 36 into which the PDA or cell phone is plugged. The keystrokes are communicated directly from the keyboard plug into the plug of the PDA, cell phone or computer device.

In order to allow the keyboard to be used on other than flat surfaces, the four sections 1, 2, 3, and 4 comprising the keyboard K1 can be locked together by means of three sliding rods 28.

The sliding rods 28 slide in channels 27 and, by pushing on handle 16, the rods 28 will slide into the “locked” position as shown in FIG. 19.

In order to unlock the keyboard, the “unlock” button 46 is depressed and the rods are pushed back into the unlocked position by means of springs 29.

In order to ensure that the rods 28 are positioned correctly in the locked and unlocked positions, i.e. the rods do not move too far in either direction, each rod 28 has a protrusion 31 which slides in a channel 32 equipped with “stops”.

In order to make the electrical connections between the four separate mylar circuit boards 50 to each other, up-stands 10 are provided in the case of the keyboard K1. When the keyboard is in its folded position, the up-stands 10 fold into depressions 11. Inside the space provided in 10, a mylar connection in the form of an “S-Curve” is accommodated. When the keyboard is closed, the connecting mylar piece will be long enough to allow for the folding motion to occur without breaking the connecting pieces.

In order to protect the edges of the keyboard when folded, cover strips 14 are provided at the first and third folds (between sections 1 and 2 and between sections 3 and 4). Cover strips 14 run the width of the keyboard K1 along the first and third folds or joints and then bend over the corners of the keyboard sections at each end thereof.

In order to protect the edges of the keyboard when folded, upstands 22 are provided at the outside edges of sections 1 and 4.

In order to lock section 1 of the keyboard K1 to quarter 4, a catch 13 locks into the up-stands 21.

In order to lock the keyboard at the first and third folds (between sections 1 and 2 and between sections 3 and 4) catches 12 are provided. The folding movement causes the catches 12 to pass through holes 18 and engage each other and thus entirely lock the abovementioned sections of the keyboard K1 to each other.

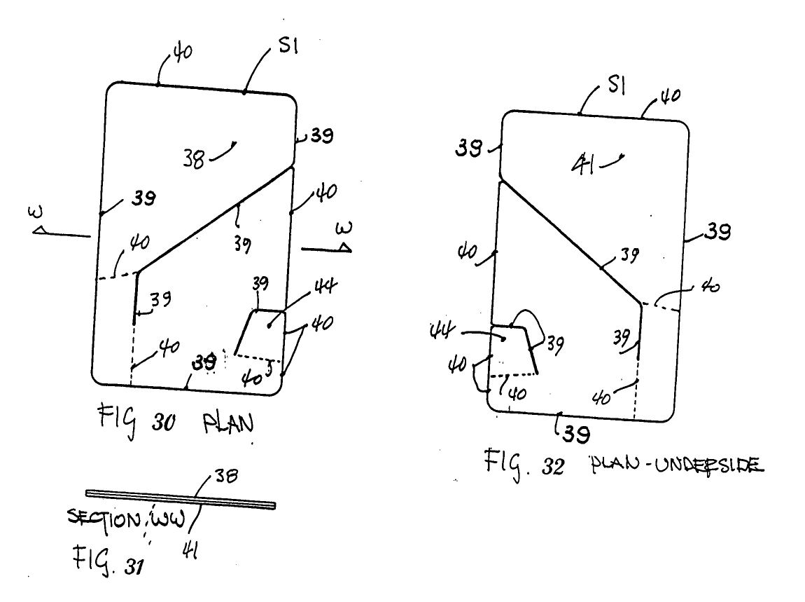

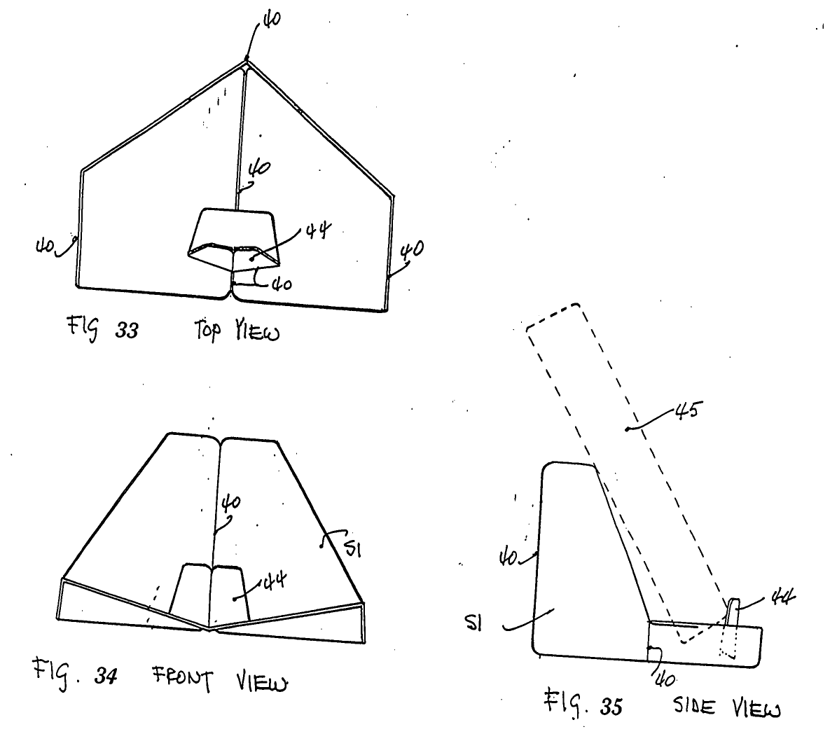

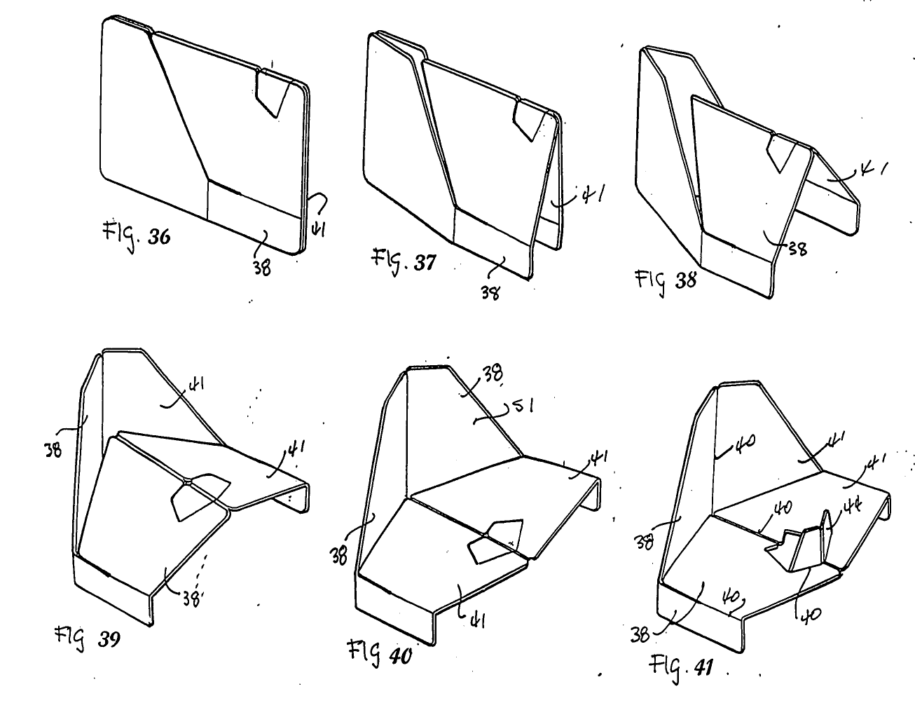

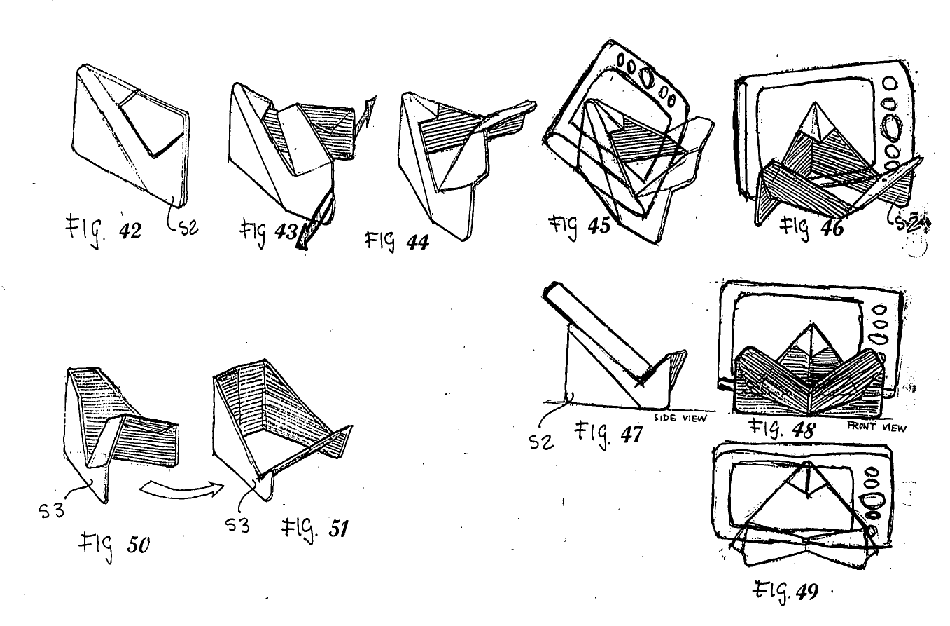

Referring to FIGS. 30-41 of the drawings, the first variant of a folding stand S1 is shown as having two “credit cards” 38 and 41 hinged at 40 to be foldable from a fully folded configuration shown in FIGS. 30, 32 and 36 to a fully unfolded configuration shown in FIG. 41. (FIGS. 36 through 41 are perspective views of the unfolding sequence whereby FIG. 36 is fully folded and FIG. 41 is fully open.)

The folding stand is as per FIG. 30. The folding stand S1 will be folded along lines 39 and 40 (with lines or edges 39 left open) so as to be unfolded into a stand able to stand on a flat surface without support whilst supporting a PDA or cell phone 45 so that the screen of the PDA or cell phone is at an angle of approximately 45 degrees to the vertical and able to receive the IR communication from the keyboard K1. Up-stand 44 consists of a piece of credit card 38 and a piece of credit card 41, cut and folded to create an up-stand capable of stopping a PDA or cell phone from slipping off the stand S1 whilst said PDA or cell phone is at an angle of 45 degrees to the vertical.

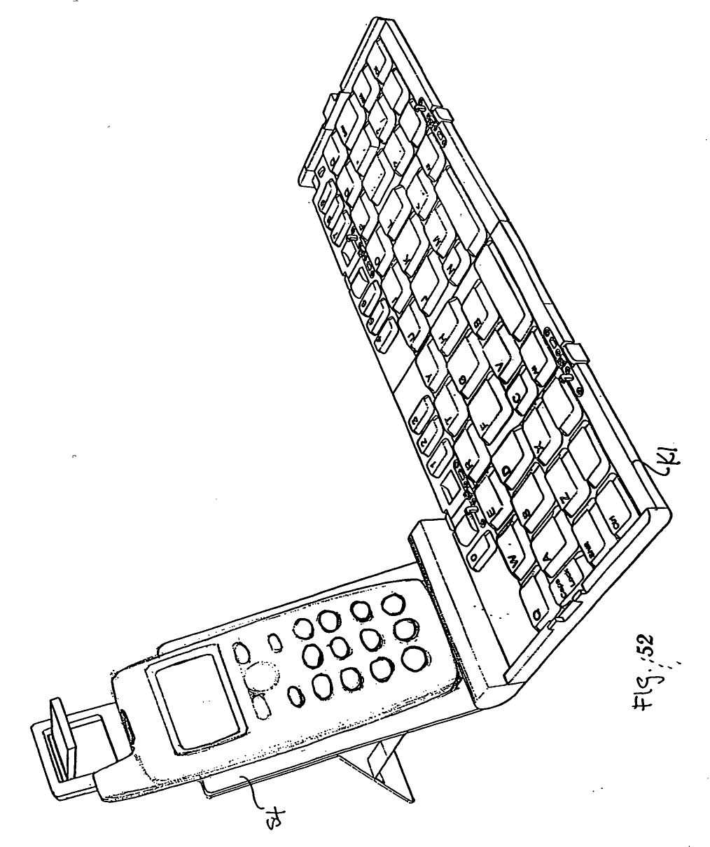

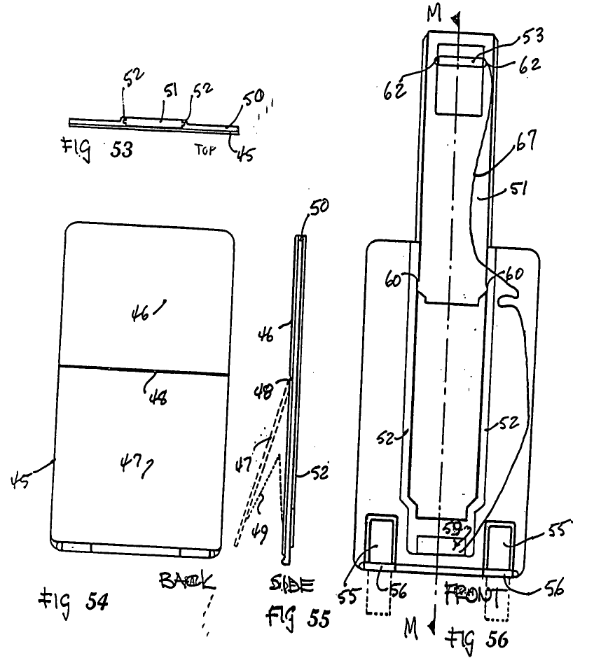

Two other variants, S2 and S3 are shown of stands in which two credit cards have been utilized for the creation thereof. Variant 2 is shown in FIGS. 43 through 50 and a third version is illustrated in FIGS. 50 and 51.

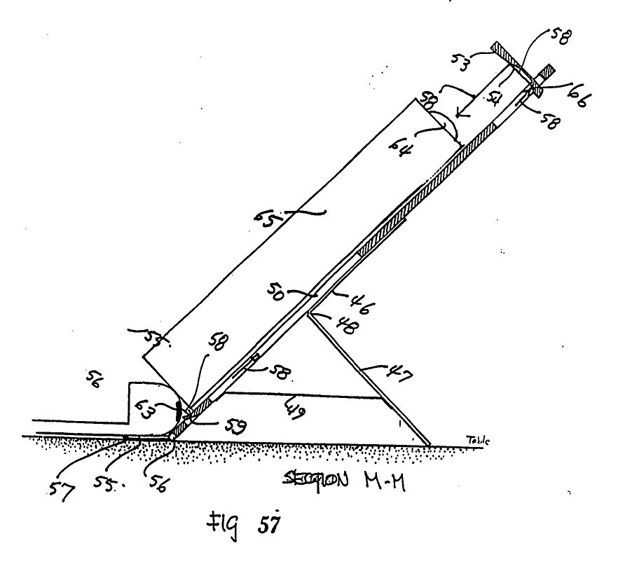

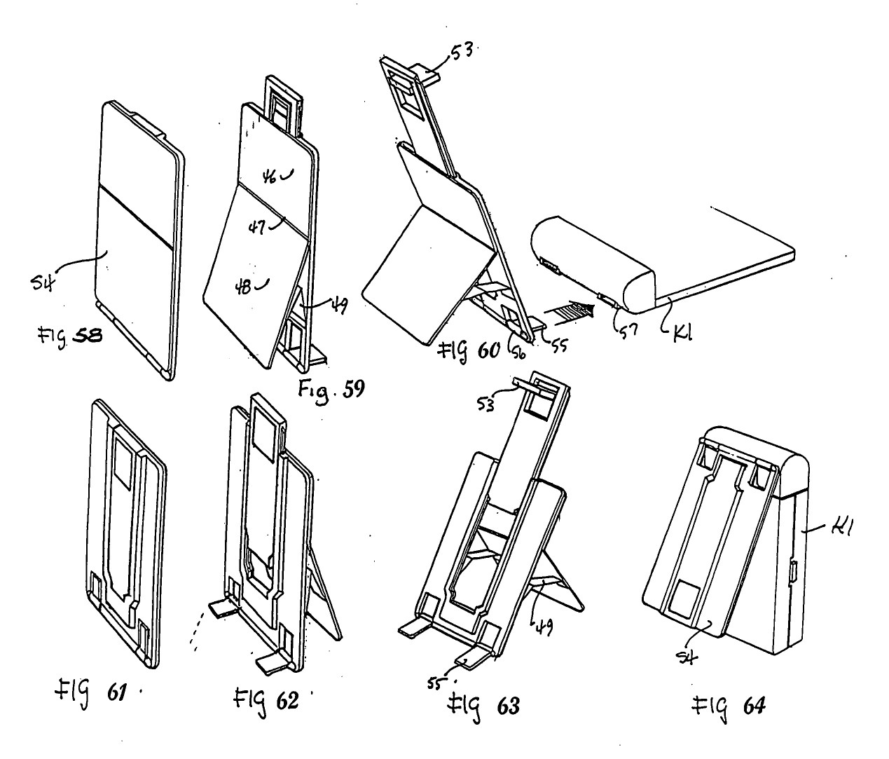

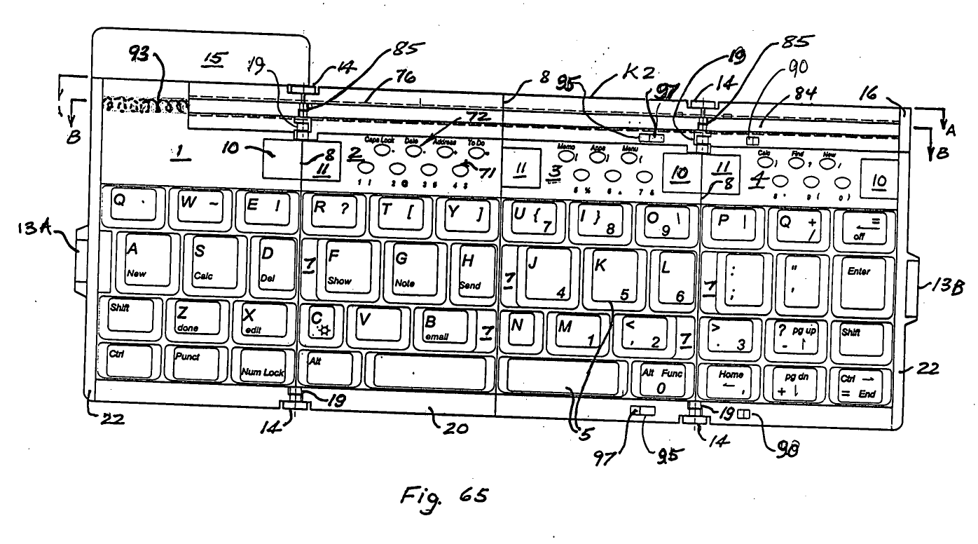

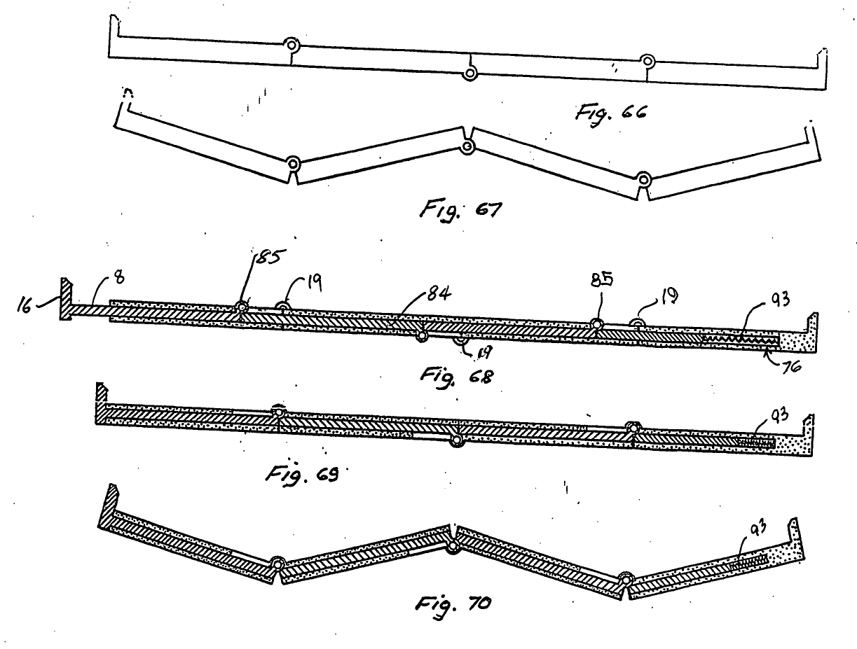

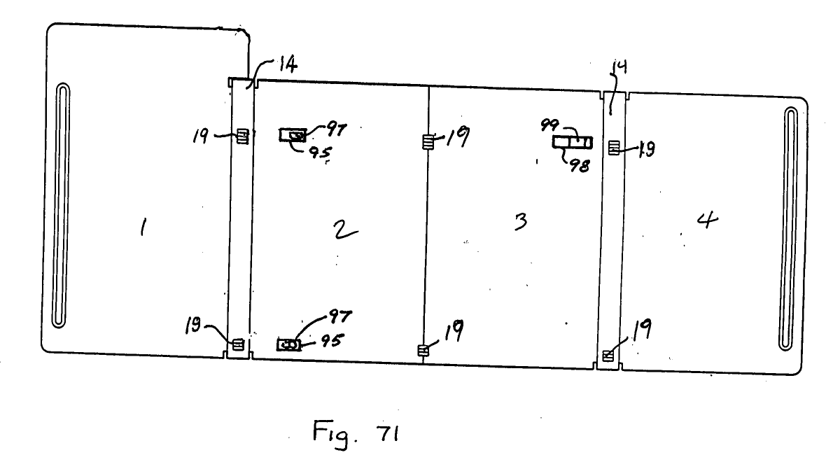

Referring to FIGS. 52 through 64 (inclusive) of the drawings, a folding stand S4 is shown as having the form factor of two “credit cards”, 45 and 50 whereas the back of the stand S4, is constructed of a credit card 45 which is the thickness of one credit card and the front of the stand S4 is constructed of a credit card 50 which is the thickness of two credit cards.

The bottom portion 47 of the back 45 of the stand S4 is folded along hinge 48 so as to create a leg 47. The leg 47 is restrained by a MYLAR strip 49 to allow the body of the stand 50 to obtain an angle of 45 degrees to the vertical and thus allow a PDA or cell phone to lie against the rear credit card 50 at said angle.

The body of the stand S4 is cut and provided with channels 52 so as to allow the center portion 51 of the body 50 to slide upwards to a fully extended position until stopped by stops 60.

A plastic reflector piece 53, hingedly connected to the sliding portion 51, is rotated until it is at 90 degrees to the sliding portion 51.

The stand S1 is plugged into the keyboard K1 by means of opening the clips 55 from the front of the stand S1 and sliding them into the female 57 of keyboard K1.

An infra-red transmitter 63 reflects the keystroke signals from the keyboard K1 onto a prism 59 which reflects the IR beam 58 up to the reflector 53, which reflector 53 has cut and mirrored surfaces 54 and 66 which deflect the IR beam 58 into the IR receiver 64 of the PDA or cell phone 65 thus allowing the keyboard signal to be transmitted to the PDA or cell phone so that the keyboard strokes in keyboard K1 can be converted into text which can be read on the screen of the PDA or cell phone 65.

In another embodiment of this invention, the IR beam is transmitted from the keyboard IR transmitter 63 into the prism 59 which prism 59 is connected to the reflector 53 via a fiber-optic cable embedded into the front 50 and the slide 51 of the stand S1 thus allowing the keyboard signal to be transmitted to the PDA or cell phone so that the keyboard strokes in keyboard K1 can be converted into text which can be read on the screen of the PDA or cell phone 65.

Referring to FIG. 65, an alternative keyboard K2, identical in the layout of the keys in the first four rows to the keys in those rows in the keyboard of FIG. 1, has smaller keys 71 than keys 9 in FIG. 1. In addition, there are small function keys 72 along the top of the keyboard K2. A locking system consists of a handle 16, which connects to an elongated rod 84 slidable in a channel 76, which has a biasing spring 93 at a closed end thereof. The rod 84 has hinge couplings 85 aligned with the fold lines 8 of the keyboard sections 1, 2, 3, and 4 when the keyboard is unlocked. When handle 16 is forced out by biasing spring 93 (see FIG. 68), it causes the rod 84 to move to the right and the hinge couplings to move away from the fold lines 8, making it impossible for the sections 1, 2, 3, and 4, to fold relative to one another.

Section 4 has two projections 90 proximate the upper and lower regions of section 4 and section 3 has corresponding openings 95 positioned to receive projections 90 when sections 3 and 4 are folded together. Projections 90 push down hinged hooks 97 which are caused to project out a back surface of section 3. Hooks 97 pass through openings 98 and catch on catches 99 to hold the back sections 1, 2, and 3 together. Another catch 13A on section 1 engages a catch receptacle 13B on section 4.

Accordingly, while this invention has been described with reference to illustrative embodiments, this description is not intended to be construed in a limiting sense. Various modifications of the illustrative embodiments, as well as other embodiments of the invention, will be apparent to persons skilled in the art upon reference to this description. It is therefore contemplated that the appended claims will cover any such modifications or embodiments as fall within the true scope of the invention.

I claim:

1. A foldable keyboard for use with a portable or stationary communication device, comprising:
a plurality of sections joined edge-to-edge to form a flat panel having a width equal to a total width of said plurality of sections, each section containing keys and said each section having a joint between it and an adjacent section, said each section foldable with respect to said adjacent section about said joint, said keys lying along at least three rows with keys in a center row being full-sized in two orthogonal directions and keys in a top and bottom row on either side of and adjacent to said center row being full-sized along a length of said top and bottom rows but reduced in size in a direction perpendicular to said top and bottom rows, said keys in said top and bottom rows having no scalloped projections.

2. The foldable keyboard of claim 1, including a lock operative to lock said plurality of sections together in an unfolded position, said lock comprising a rod slidable in a channel, said rod and channel extending across all of said joints, said rod having hinged couplings normally aligned with said joints when said sections are foldable and movable automatically away from said joints outwardly with said rod extending across each of said joints and thereby locking each one of said sections against folding movement relative to others of said sections.

3. The foldable keyboard of claim 2, wherein said rod and said channel each have a T-shaped cross-section.

4. The foldable keyboard of claim 1, wherein the number of sections is four and the number of joints is three.

5. The foldable keyboard of claim 1, including an infra red transceiver to communicate with an external communication device.

6. The foldable keyboard of claim 1, including an infra red transceiver mounted along an edge of said foldable keyboard

7. The foldable keyboard of claim 1, including a stand operative to hold a portable communication device at an inclined angle to vertical adjacent to said infra red transceiver to enable wireless communication with said portable communication device.

8. The foldable keyboard of claim 1, wherein each of said sections has an aluminum bottom plate, a mylar circuit board supported by said bottom plate, a silicone matt supporting said keys, said silicone matt having dome springs operative to bias said keys upwardly away from said silicon matt, and a steel base plate operative to support said keys.

9. The foldable keyboard of claim 1, wherein said keys in said center row have lateral dimensions in the range of 16 to 18 mm and gaps between adjacent keys of 1 mm.

10. The foldable keyboard of claim 1, wherein keys in said top and bottom rows have dimensions along the length of their respective rows in the range of 16 to 18 mm and perpendicular to the length of their respective rows in the range of 9 to 12 mm.

11. The foldable keyboard of claim 10, wherein the keys “D”, “C”, “H”, “N”, “L”, and “>” have a reduced dimension along a length of their respective rows in order to permit folding of said sections along an associated one of said joints.

12. The foldable keyboard of claim 10, wherein the keys “F”, “J”, “B”, “:;”, and “,<” have a lower enlarged portion.

13. The foldable keyboard of claim 1, wherein said keys project 1/32 inches above a face of said keyboard K1.

14. The foldable keyboard of claim 7, wherein said stand is foldable to a flat configuration having a thickness of not more than three credit cards and dimensions of length and width equal to that of a credit card.

15. A foldable keyboard according to claim 4, wherein an end one of said sections has a projection extending outwordly which engages and pushes hooks in a second panel adjacent said one panel when said panels are folded together and said hooks engage a catch on the third panel adjacent to said second panel and locks said one, second, and third panels together.

16. A keyboard for use with a portable or stationary communication device, comprising:
a flat panel,
a plurality of keys lying along at least a center row and a top and bottom row of said flat panel with said keys in said center row being full-sized along a length of said center row and perpendicular to said length of said center row and keys in a top and bottom row on either side of and adjacent to said center row being full-sized along a length of said top and bottom rows but reduced in size in a direction perpendicular to said top and bottom rows, said keys in said top and bottom rows having no scalloped projections.
